(19) United States
(12) Patent Application Publication
(10) Pub. No.: US 2007/0156667 A1
(43) Pub. Date: Jul. 5, 2007

(54) Method and apparatus for identifying related media across playback platforms

(76) Inventors: Dongge Li, Hoffman Estates, IL (US); Bhavan R. Gandhi, Vernon Hills, IL (US); Cuneyt M. Taskiran, Chicago, IL (US); Wei Wang, Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/324,854

(22) Filed: Jan. 4, 2006

(51) Int. Cl. G06F 17/30

(52) U.S. Cl. 707/4

(57) ABSTRACT

A network element of choice receives (101) information and uses (102) that information to develop a content search query. That network element then instigates (103) a content search using the content search query and receives (104), in turn, content search results comprising a plurality of content items. Profile information for a plurality of playback platforms is then accessed (105) and used (106) to identify which of the content items are best played back on particular ones of the playback platforms.

### TECHNICAL FIELD

This invention relates generally to media content identification.

### BACKGROUND

Media content of various kinds is readily available with additional content becoming accessible on a regular basis. Often (though not always) such content has a substantive core. For example, a given content item can relate to facts, commentary, and/or opinions as pertain to a particular news event, a particular product, person, or business, or can comprise an entertainment offering that presents, for example, a fixed or interactive story line (with numerous other examples and possibilities being available).

Such content hails from a wide variety of heterogeneous sources and can vary considerably from one another in any of many ways. For example, content varies both with respect to substance as well as playback modality. Content also varies with respect to temporal creation and/or availability.

Similarly, the prior art contains a wide (and seemingly ever-growing) variety of playback platforms and devices. Such playback platforms differ greatly with respect to supported modalities and also with respect to form factor. For example, some playback platforms will only support an audio modality, some playback platforms will only support textual/graphic modalities, and yet other playback platforms may only support audio/visual modalities.

Such circumstances present numerous significant challenges. End users display an increasing interest in being able to access and receive content of interest with great transparency and ease. This includes being able to play back content of interest on any of a wide variety of playback platforms that a given end user may use. On the one hand, meeting such a challenge requires being able to locate suitable content of interest. On the other hand, such requirements also typically entail constraining in some manner the otherwise substantively-acceptable content to ensure compatibility with a particular playback platform.

One prior art approach will often meet such needs by severely limiting content selection with respect to modality and/or content identification. For example, by one approach, an end user may only retrieve content from a sole content source. The latter, in turn, attempts to ensure provision of content using only compatible modalities.

As another example, by another approach, an end user may be severely restricted with respect to the modality of content retrieval/presentation. Browser-based interaction via the Internet with various content sources represents a relevant example in this regard.

Such techniques are insufficient to meet growing needs for content access. Approaches such as these tend to present undue constraints with respect to content sources, content selection, and/or content delivery. This, in turn, can lead to user frustration and/or at least a sense of incompleteness with respect to the substantive content being sought.

### BRIEF DESCRIPTION OF THE DRAWINGS

The above needs are at least partially met through provision of the method and apparatus for identifying related media across playback platforms described in the following detailed description, particularly when studied in conjunction with the drawings, wherein:

FIG. 1 comprises a flow diagram as configured in accordance with various embodiments of the invention;

FIG. 2 comprises a schematic illustrative example of a relationship graph as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element of choice receives information and uses that information to develop a content search query. That network element then instigates a content search using the content search query and receives, in turn, content search results comprising a plurality of content items. Profile information for a plurality of playback platforms is then accessed and used to identify which of the content items are best played back on particular ones of the playback platforms.

The aforementioned information can comprise, in and of itself, a properly formatted content search query or, perhaps more typically, can comprise information that relates in some general way with content of interest to a particular end user. The network, element can then use that information regarding content of interest to formulate a properly formatted content search query. The content search itself can be effected as desired. This can comprise use of a local search engine, a remote search engine, or both as desired.

By one optional approach, if desired, this process can further comprise identifying predetermined kinds of relationships as may exist as between various ones of the plurality of identified content items. Various kinds of relationships may be considered in this regard. One potentially useful example of a predetermined relationship is when a first one of the plurality of content items comprises a part of another one of the plurality of content items. Another potentially useful example of a predetermined relationship is when a first one of the plurality of content items is related to another one of the plurality of content items. Yet another potentially useful example of a predetermined relationship is when a first one of the plurality of content items is substantively similar to another one of the plurality of content items. Other useful relationships may be employed as well as desired.

So configured, content of interest to a given end user is readily identified without any particular regard for content type, bearer channel, modality, or the like. Instead, content of substantive interest is identified and then parsed or categorized with respect to suitability for playback on various playback platforms as may be available (at present or over time) with respect to that given end user and/or such other playback target as may be appropriate. This, in turn, permits an end user to receive substantive content of interest in a form suitable for consumption on a given selected playback platform. Optional use of the relationship information can provide further powerful opportunities to permit such an end user to readily navigate amongst available content selections in ways that can be highly intuitive, meaningful, and useful.

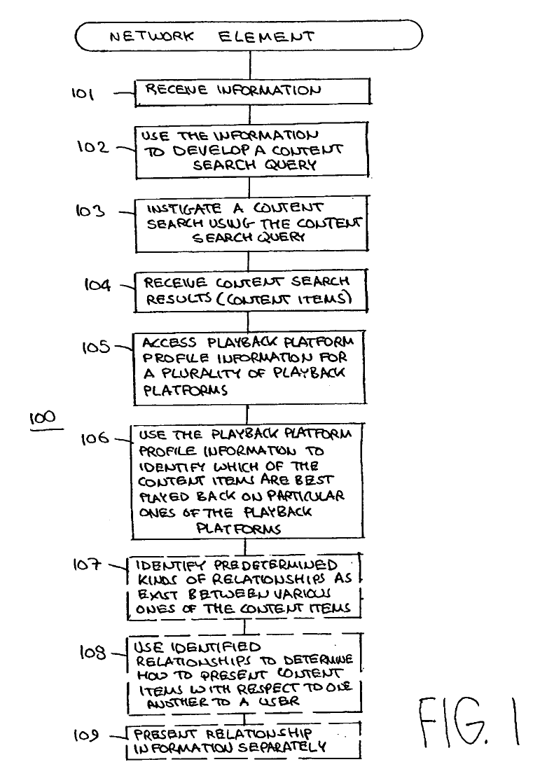

These and other benefits may become clearer upon making a thorough review and study of the following detailed description. Referring now to the drawings, and in particular to FIG. 1, an illustrative process 100 will be described. This process 100 can be implemented by a network element of choice including, but not limited to, a media server, a personal computer, and so forth. Those skilled in the art will understand and recognize that the expression “network element” can refer to a physical entity (such as a stand-alone or shared hardware platform) or to a logical entity (as when the steps of the described process 100 are distributed over a plurality of discrete platforms).

This process 100 provides for receiving 101 information at the network element. This information will typically originate with an end user and may be sourced, for example, by a handheld wireless communication device (such as a cellular telephone, a push-to-talk device, a laptop or handheld computer, a personal digital assistant, and so forth, to note but a few). This information identifies or otherwise corresponds to informational content of interest to the end user. In this regard this information may comprise a general averment with respect to the informational content of interest (such as a news headline, a question, or a statement) or can comprise, for example, a search statement (such as, for example, search terms presented with corresponding Boolean limitations). The precise form of the received information will depend upon and vary with the needs, requirements, limitations, and/or capabilities as characterize a given application setting.

If desired, this received information can also comprise optional information that identifies a selected target content playback platform (or platforms). For example, the received information can identify a cellular telephone that sourced the received information as being the intended playback target for corresponding located content. As another example, the received information can specifically identify a different playback platform (other than the device that sourced the received information) such as a television, a computer, a home media network, a vehicle-mounted radio, and so forth.

This process 100 then provides for using 102 the received information to develop a content search query. As noted above, the received information may itself comprise a properly formatted content search query. In such a case this step 102 can simply comprise using the received information in its received form. The received information may also comprise, however, something other than a properly formatted content search query. In such a case this step 102 can comprise using the received information to formulate an appropriately formatted content search query. This can comprise, for example, parsing the information to identify search terms to be used to develop the content search query.

Various query formation techniques are known in the art and others are likely to be developed in the future. Furthermore, the present teachings are not particularly sensitive to the selection and use of any particular technique in this regard. Therefore, for the sake of brevity, further elaboration regarding such query formation techniques will not be presented here.

The network element then instigates 103 a content search using the aforementioned content search query. Depending upon the limitations and/or capabilities of a given application setting, this step 103 can comprise using a local search engine, a remote search engine, or both a local and a remote search engine. Search engines of various types are presently known with others likely to be developed in the future. The present teachings are not overly sensitive to the selection and use of any particular approach or strategy in this regard.

It will be noted, however, that these teachings will readily accommodate a relatively wide-ranging search. In particular, this process 100 will tolerate (and, in fact, benefit from) instigating a content search for content regardless of content type and/or the delivery bearer channel over time. This, of course, differs dramatically from many prior art search strategies that more typically limit and constrain content searches in this regard. Accordingly, this process 100 will readily accommodate and permit instigating a content search for content that shares, for example, substantive similarly with one another but that may differ with respect to at least one of temporal availability, content delivery bearers (such as, for example, the Internet, a television broadcast, a radio broadcast, and so forth) that are technologically incompatible with one another, and/or even playback modality (such as, for example, video, still images, text, audio, and so forth).

In turn, the network element then receives 104 corresponding content search results comprising, for example, a plurality of content items. As noted above, these content items can comprise a heterogeneous offering with respect to their sources, modalities, content delivery bearers, respective timeframes, and so forth. By one approach, these content items can themselves comprise the content items in a playable form. Perhaps more usefully, however, these content items can comprise, at least in part, identifiers for corresponding content items (that is, an identifier for a corresponding playable data item). In such a case, if desired, the content items need not themselves comprise any substantial portion of a media content as might be represented by such an identifier (though some insubstantial portion, such as a title, abstract, first sentence or paragraph, or other insignificant abridgement might be include with or otherwise comprise a part of such an identifier).

Various kinds of identifiers are known in the art and may be employed for these purposes. As one illustration, such an identifier may comprise a link such as a hyperlink that leads to specific media content as corresponds to that identifier. Such links and other identifiers are well known in the art and the present teachings are not particularly sensitive to the selection and use of any particular identifier approach. Accordingly, further elaboration regarding such identifiers will not be provided here for the sake of brevity.

This process 100 then provides for accessing 104 playback platform profile information for a plurality of playback platforms. These playback platforms may comprise, those playback platforms as were initially identified by the received information first noted above. As another example, these playback platforms may comprise all playback platforms as may be available to or otherwise associated with the end user who seeks the content at issue. In an expected embodiment these playback platforms can vary from one another in essentially any way and are further likely to be widely geographically distributed with respect to one another as well.

The profile information for such playback platforms can comprise any information that may be useful to the described process 100. Examples include, but are not limited to:
information regarding a delivery address;
information regarding a corresponding bearer channel;
information regarding content modality requirements and/or capabilities;
information regarding present and/or future availability;
information regarding present and/or future end user accessibility; and/or information regarding user preference.
   Such profile information may be locally stored with respect to the network element and/or may be remotely sourced. For example, a profile information server containing all or part of such information may be available to the network element.

This process 100 then provides for using 106 the playback platform profile information to identify which of the content items are best played back on particular ones of the playback platforms. This can essentially comprise comparing the characterizing physical parameters for each content item against the profile information. As a simple example, a digitized version of a television broadcast may be best played back on a desktop computer having a broadband Internet connection and a suitable playback program as versus other available playback options (such as, for example, an automobile radio).

So configured, this process 100 can then support a variety of corresponding resultant actions. For example, provision of specific appropriate content playback: opportunities can be automatically provided to each playback platform as may be available to the initiating source user (and/or a target or targets as may have otherwise been identified). As another example, links to the substantive media content can be provided to the end user via the platform that sourced the aforementioned received information. By one approach only content that is usefully playable on that platform will be displayed for selection by the end user. By another approach, even content that is not usefully playable on that platform will be displayed. In the latter case, if desired, this process 100 may also accommodate permitting the end user to select such content and to direct that such content be made available at a different playback platform of choice.

Optionally, if desired, this process 100 can further comprise identifying 107 predetermined kinds of relationships as exist between various ones of the plurality of content items. Various kinds of relationships may serve a useful purpose by this approach. Examples include, but are certainly not limited to:
when a first one of the plurality of content items comprises a part of another one of the plurality of content items;
when a first one of the plurality of content items is related to another one of the plurality of content items; and/or
when a first one of the plurality of content items is substantively similar to another one of the plurality of content items.

If desired, this step can further comprise providing weighting values with respect to at least some of the identified relationships. For example, when the relationship of interest comprises temporal distance, a larger weighting value can reflect temporal proximity as between two content items while a lower weighting value can reflect a greater temporal distance as between such content items. As another example, when the relationship of interest comprises substantive similarity, a relatively larger weighting value can reflect a relatively higher degree of perceived substantive similarity.

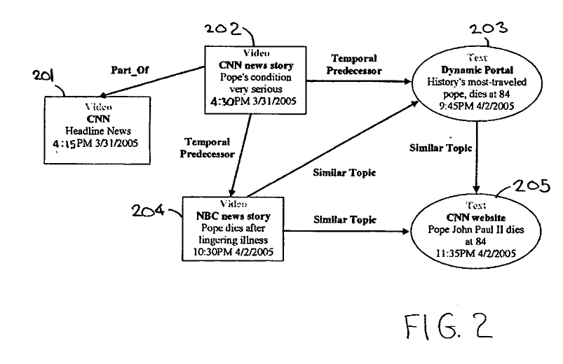

FIG. 2 provides a simple illustrative schematic example of a relationship graph as might be developed by this approach. In this example the substantive content of interest to an end user comprises the passing of Pope John Paul II and five corresponding content items comprise the results of a corresponding content search. A first content item 201 comprises a video that is determined to have the relationship of being part of a second content item 202. A third and fourth content item 203 and 204 are determined to have the relationship of having the second content item 202 as a temporal predecessor (that is, the second content item 202 became available or was initially provided for playback at an earlier point in time than the third and fourth content items 203 and 204).

This illustrative example also depicts the third and fourth content items 203 and 204 as well as a fifth content item 205 as having the relationship of presenting a substantively similar topic. By these teachings, all such relationships of interest can be identified 107. Those skilled in the art will also see and appreciate that the example provided in FIG. 2 reflects a body of candidate content items that different from one another at least with respect to their playback modality. In particular, three of the content items (201, 202, and 204) comprise video content while two of the content items (203 and 205) comprise textual content.

It may also be observed that the temporal context for each content item has been captured as well. For example, the second content item became available at 4:30 PM on Mar. 31, 2005 whereas the text comprising the fifth content item became available at 11:35 PM on Apr. 2, 2005. This temporal context and the temporal relationships between the identified content items can also be usefully employed as described below.

If desired, the nodes of this type of graphical relationship may point to additional information about the specific content item including an identifier or link to the content itself. As such, the relationship information can be stored independently of the actual content items themselves and their corresponding metadata. This, in turn, provides considerable flexibility to an end user with respect to navigating through a content collection and consuming only specific content items of interest. Also, if desired, this content relationship graph can be transmitted to other playback platforms for consumption elsewhere, thus permitting continuation of the consumption cycle on other playback platforms. Used in such ways the playback profile information of the destination playback platform would serve as a filter for the relationship graph to identify media that is consumable on that device.

Referring again to FIG. 1, this process 100 can then provide for using 108 these identified predetermined kinds of relationships to determine, for example, how to present content items with respect to one another to a user. For example, by one approach, available content items can be presented as a two dimensional matrix to an end user on a display. Particular content items can be positioned within that matrix such that, for example, more recent content items appear to the right hand side of the matrix while less recent content items appear more to the left. As another example, content items having a greater substantive similarity to the original search criteria can be positioned more to the upper portion of the matrix while less similar results and content options can be positioned more towards the lower portion of the matrix. If desired, additional dimensions can be employed (for example, by permitting a user to appear to move deeper into the display or upwardly in the Z plane from the display) to reflect other relationships.

The above-mentioned weighting information can of course be used when making such positioning decisions. If desired, such weighting information may also be displayed to the end user. Also if desired, the identified relationship information may be presented to the user, either in conjunction with the content items themselves or separately therefrom.

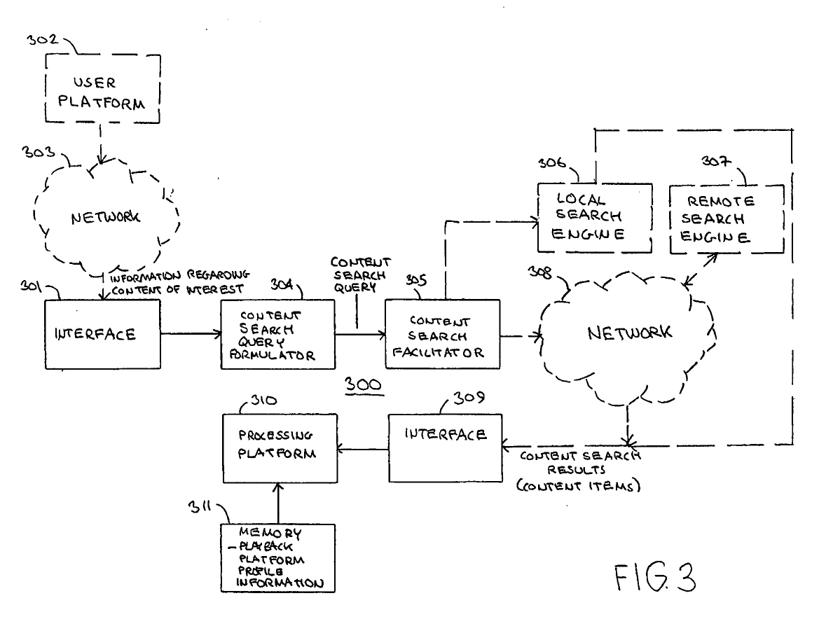

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

This illustrative embodiment comprises a network element 300 to support one or more of the teachings set forth above. This network element 300 comprises an interface having an input to receive information as described above regarding content of interest. Such information may be sourced, for example, by an end user using a corresponding user platform 302 of choice (such as, but not limited to, a wireless handheld communication device). In a typical scenario this user platform 302 will communicate such information to the interface 301 via an intervening network 303 (which may itself comprise one or more discrete networks, one or more of which may comprise a wireless network). By another approach, if desired, the network element 300 can itself comprise, in whole or in part, the user platform 302 (as when the functionality of the network element 300 comprises a part of a user platform 302). Such networks and user platforms are generally well known in the art and require no further description here.

This illustrative network element 300 also comprises a content search query formulator 304 having an input operably coupled to receive the information regarding content of interest from the interface 301 and an output that provides a corresponding content search query. As noted above, this content search query may comprise the information regarding content of interest (especially when the latter comprises an already properly composed and formatted content search query) or may be formed as a function of the incoming information.

A content search facilitator 305 has an input that receives this content search query. This content search facilitator 305 then uses that content search query to facilitate instigation of a content search such as that described above. Such a search can comprise, for example, submitting the content search query to an optionally provided local search engine 306. In lieu of using local resources (or in addition thereto), the content search facilitator 305 can also provide the content search query to a remote search engine 307 (via, for example, an intervening network of choice such as an intranet or an extranet such as the Internet). (Those skilled in the art will recognize and understand that this network 308 may be different than, or the same as, the previously mentioned network 303.)

Another interface 309 (which may be different than or the same as the previously mentioned interface depending upon the needs and requirements of a given application setting) has an input to receive resultant content search results. By one approach these content search results comprise a plurality of content items (which may comprise identifiers for a corresponding content item) as described above. A processing platform 310 is operably coupled to then receive these content search results and is further operably coupled to a memory 311 having stored therein playback platform profile information for a plurality of playback platforms as has also been described above.

This processing platform 310 is configured and arranged to use the playback platform profile information to identify which of the content items are best played back on particular ones of the playback platforms. This can be achieved, for example, by observance of the teachings set forth above. If desired, this processing platform 310 can further be configured and arranged to permit identification of predetermined kinds of relationships as may exist between various ones of the plurality of content items and to use that relationship information to determine, for example, how to present selectable content items with respect to one another to a user (and again as described above).

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform or can be distributed over a plurality of implementing platforms. It will also be understood that such a shared platform may comprise a wholly or at least partially programmable platform as are known in the art.

These teachings are readily employed to accommodate and leverage a variety of existing content opportunities. For example, these teachings can serve to facilitate provision of a media association system that analyzes and links multimedia content from heterogeneous sources and a media association network structure that facilitates efficient retrieval and mining of content. Those skilled in the art will appreciate that such services and results and achieved in a relatively seamless manner across a diverse user base, a diverse content base, and a diverse playback platform base. Those skilled in the art will further likely especially appreciate that these teachings are readily employed to facilitate relating and sharing content having utterly divergent and incompatible modalities. This can include, if desired, the recognition of one or more relationships amongst such content opportunities and the use of that relationship information to better facilitate provision of such diverse content to an end user.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, when content of potential interest is scheduled to be broadcast (via, for example, television or radio) without other means of persistence being available, these teachings can be readily supplemented to provide for automated recording of such broadcasts to thereby ensure the subsequent availability of such content in accordance with these embodiments. Such an approach may also be useful to facilitate a shift in presentation modality. For example, this approach could serve to permit a personal computer that lacks broadcast reception capabilities to receive a digitized stored version of a broadcast via a modality that the personal computer could support (such as an Internet offering).

We claim:

1. A method comprising:
at a network element:
receiving information;
using the information to develop a content search query;
instigating a content search using the content search query;
receiving content search results comprising a plurality of content items;
accessing playback platform profile information for a plurality of playback platforms;
using the playback platform profile information to identify which of the content items are best played back on particular ones of the playback platforms.

2. The method of claim 1 wherein receiving information comprises receiving information that was sourced by a handheld wireless communication device.

3. The method of claim 1 wherein using the information to develop a content search query comprises, at least in part, parsing the information to identify search terms to be used to develop the content search query.

4. The method of claim 1 wherein instigating a content search using the content search query comprises using a local search engine.

5. The method of claim 1 wherein instigating a content search using the content search query comprises using a remote search engine.

6. The method of claim 1 wherein the plurality of content items each comprise, at least in part, an identifier for a corresponding content item.

7. The method of claim 6 wherein the plurality of content items do not comprise any substantial portion of a media content that is represented by the identifier.

8. The method of claim 6 wherein at least one of the identifiers comprises a link that leads to media content as corresponds to that identifier.

9. The method of claim 1 further comprising:
identifying predetermined kinds of relationships as exist between various ones of the plurality of content items.

10. The method of claim 9 wherein the predetermined kinds of relationships comprise, at least in part:
when a first one of the plurality of content items comprises a part of another one of the plurality of content items;
when a first one of the plurality of content items is related to another one of the plurality of content items;
when a first one of the plurality of content items is substantively similar to another one of the plurality of content items.

11. The method of claim 9 wherein identifying predetermined kinds of relationships as exist between various ones of the plurality of content items further comprises providing weighting values with respect to at least some of the relationships that are so identified.

12. The method of claim 9 further comprising:
using identified predetermined kinds of relationships as exist between various ones of the plurality of content items to determine how to present selectable content items with respect to one another to a user.

13. The method of claim 9 further comprising:
presenting information regarding identified relationships separately from information regarding the content items themselves.

14. The method of claim 1 wherein receiving information comprises receiving information that identifies a selected target content playback platform.

15. The method of claim 1 wherein instigating a content search using the content search query comprises instigating a content search for content that shares substantive similarity with one another but that may differ with respect to at least one of:
temporal availability;
content delivery bearers that are technologically incompatible with one another;
modality.

16. The method of claim 1 wherein instigating a content search using the content search query comprises instigating a content search for content regardless of content type and bearer channel over time.

17. A network element comprising:
an interface having an input to receive information regarding content of interest;
a content search query formulator having an input operably coupled to receive the information regarding content of interest and an output comprising a content search query;
a content search facilitator having an input operably coupled to receive the content search query;
an interface having an input to receive content search results comprising a plurality of content items;
a memory having stored therein playback platform profile information for a plurality of playback platforms;
a processing platform operably coupled to receive the content search results and being operably coupled to the memory and being configured and arranged to use the playback platform profile information to identify which of the content items are best played back on particular ones of the playback platforms.

18. The network element of claim 17 wherein the interface having an input to receive information regarding content of interest comprises an interface to receive input from a handheld wireless communication device.

19. The network element of claim 17 wherein the content search facilitator has an output operably coupled to at least one of:
a local search engine;
a remote search engine.

20. The network element of claim 17 wherein the plurality of content items each comprise, at least in part, an identifier for a corresponding content item.

21. The network element of claim 17 wherein the processing platform is further configured and arranged to:
identify predetermined kinds of relationships as exist between various ones of the plurality of content items;
use identified predetermined kinds of relationships as exist between various ones of the plurality of content items to determine how to present selectable content items with respect to one another to a user.
